(19) United States
(12) Patent Application Publication
(10) Pub. No.: US 2026/0086428 A1
(43) Pub. Date: Mar. 26, 2026

(54) Camera Module with Continuous Variable Aperture Assembly

(71) Applicant: Apple Inc., Cupertino, CA (US)

(72) Inventor: Tyler Bruce Cater, Campbell, CA (US)

(73) Assignee: Apple Inc., Cupertino, CA (US)

(21) Appl. No.: 19/315,296

(22) Filed: Aug. 29, 2025

Related U.S. Application Data
(60) Provisional application No. 63/698,514, filed on Sep. 24, 2024.

(51) Int. Cl. G03B 9/06; G03B 13/36; G03B 30/00

(52) U.S. Cl. CPC G03B 9/06; G03B 13/36; G03B 30/00

(57) ABSTRACT

A camera includes an image sensor and a variable aperture assembly. The variable aperture assembly includes an optical assembly having one or more lenses. The optical assembly is positioned along a light path that extends from an object side of the one or more lenses, through the one or more lenses, and to the image sensor. The variable aperture assembly also includes an actuator configured to move the optical assembly along the light path. The variable aperture assembly further includes a variable aperture mechanism configured to modulate a diameter of the light path adjacent the optical assembly. In addition, the variable aperture assembly includes a mechanical coupling configured activate the variable aperture mechanism to modulate the diameter of the light path adjacent the optical assembly during movement of the optical assembly along the light path.

This application claims benefit of priority to U.S. Provisional Application Serial No. 63/698,514, entitled “Camera Module with Continuous Variable Aperture Assembly,” filed September 24, 2024, and which is hereby incorporated herein by reference in its entirety.

### BACKGROUND

### TECHNICAL FIELD

This disclosure relates generally to lens aperture for a camera module and, particularly to continuous variable lens aperture.

### DESCRIPTION OF THE RELATED ART

The advent of small, mobile multipurpose devices such as smartphones and tablet or pad devices has resulted in a need for high-resolution, small form factor cameras for integration in the devices. Some cameras may incorporate optical image stabilization (OIS) mechanisms that may sense and react to external excitation/disturbance by adjusting location of the optical lens on the X and/or Y axis in an attempt to compensate for unwanted motion of the lens. Furthermore, some cameras may incorporate an autofocus (AF) mechanism whereby the object focal distance can be adjusted to focus an object plane in front of the camera at an image plane to be captured by the image sensor. Additionally, some cameras may incorporate a variable lens aperture for modulating the amount of light received by the lens(es).

### BRIEF DESCRIPTION OF THE DRAWINGS

FIG. 1 illustrates components of an example camera having a variable aperture assembly that may, for example, change the diameter of an aperture/opening to change an amount of light that reaches lenses of an optical assembly and/or an image sensor in small form factor cameras, according to at least some embodiments. FIG. 1 shows an overhead view of the exterior of the camera.

FIG. 2 illustrates components of an example camera having a variable aperture assembly that may, for example, change the diameter of an aperture/opening to change an amount of light that reaches lenses of an optical assembly and/or an image sensor in small form factor cameras, according to at least some embodiments. FIG. 2 shows a cross-sectional view of the camera with the variable aperture assembly in a first position.

FIG. 3 illustrates components of an example camera having a variable aperture assembly that may, for example, change the diameter of an aperture/opening to change an amount of light that reaches lenses of an optical assembly and/or an image sensor in small form factor cameras, according to at least some embodiments. FIG. 3 shows a cross-sectional view of the camera with the variable aperture assembly in a second position.

FIG. 4 illustrates components of an example variable aperture assembly that may, for example, change the diameter of an aperture/opening to change an amount of light that reaches lenses of an optical assembly and/or an image sensor in small form factor cameras, according to at least some embodiments. FIG. 4 shows an overhead view of the variable aperture assembly.

FIG. 5 illustrates components of an example variable aperture assembly that may, for example, change the diameter of an aperture/opening to change an amount of light that reaches lenses of an optical assembly and/or an image sensor in small form factor cameras, according to at least some embodiments. FIG. 5 shows a cross-sectional view of the variable aperture assembly.

FIG. 6 illustrates components of an example variable aperture assembly that may, for example, change the diameter of an aperture/opening to change an amount of light that reaches lenses of an optical assembly and/or an image sensor in small form factor cameras, according to at least some embodiments. FIG. 6 shows a cross-sectional view of a section of the variable aperture assembly illustrated in FIG. 5.

FIG. 7 illustrates components of an example variable aperture assembly that may, for example, change the diameter of an aperture/opening to change an amount of light that reaches lenses of an optical assembly and/or an image sensor in small form factor cameras, according to at least some embodiments. FIG. 7 shows an exploded view of the variable aperture assembly.

FIGS. 8A, 8B, 8C, and 8D, and 8D illustrates components of example variable aperture assemblies that may, for example, change the diameter of an aperture/opening to change an amount of light that reaches lenses of an optical assembly and/or an image sensor in small form factor cameras, according to at least some embodiments. FIG. 8A shows perspective view of a first cam profile of a variable aperture assembly. FIG. 8B shows perspective view of a second cam profile of a variable aperture assembly. FIG. 8C shows perspective view of a third cam profile of a variable aperture assembly. FIG. 8D shows perspective view of a fourth cam profile of a variable aperture assembly.

FIGS. 9A, 9B, 9C, and 9D illustrates components of example variable aperture assemblies that may, for example, change the diameter of an aperture/opening to change an amount of light that reaches lenses of an optical assembly and/or an image sensor in small form factor cameras, according to at least some embodiments. FIG. 9A shows perspective view of a fifth cam profile of a variable aperture assembly. FIG. 9B shows perspective view of a sixth cam profile of a variable aperture assembly. FIG. 9C shows perspective view of a seventh cam profile of a variable aperture assembly. FIG. 9D shows perspective view of an eighth cam profile of a variable aperture assembly.

FIG. 10 illustrates components of an example camera having a variable aperture assembly that may, for example, change the diameter of an aperture/opening to change an amount of light that reaches lenses of an optical assembly and/or an image sensor in small form factor cameras, according to at least some embodiments. FIG. 10 shows a cross-sectional view of the camera with the variable aperture assembly.

FIG. 11 illustrates components of an example camera having a variable aperture assembly that may, for example, change the diameter of an aperture/opening to change an amount of light that reaches lenses of an optical assembly and/or an image sensor in small form factor cameras, according to at least some embodiments. FIG. 11 shows a cross-sectional view of the camera with the variable aperture assembly.

FIG. 12 illustrates a schematic representation of an example device that may include a camera, in accordance with some embodiments.

FIG. 13 illustrates a schematic block diagram of an example computing device, referred to as computer system, that may include or host embodiments of a camera, in accordance with some embodiments.

This specification includes references to “one embodiment” or “an embodiment.” The appearances of the phrases “in one embodiment” or “in an embodiment” do not necessarily refer to the same embodiment. Particular features, structures, or characteristics may be combined in any suitable manner consistent with this disclosure.

“Comprising.” This term is open-ended. As used in the appended claims, this term does not foreclose additional structure or steps. Consider a claim that recites: “An apparatus comprising one or more processor units ….” Such a claim does not foreclose the apparatus from including additional components (e.g., a network interface unit, graphics circuitry, etc.).

“Configured To.” Various units, circuits, or other components may be described or claimed as “configured to” perform a task or tasks. In such contexts, “configured to” is used to connote structure by indicating that the units/circuits/components include structure (e.g., circuitry) that performs those task or tasks during operation. As such, the unit/circuit/component can be said to be configured to perform the task even when the specified unit/circuit/component is not currently operational (e.g., is not on). The units/circuits/components used with the “configured to” language include hardware—for example, circuits, memory storing program instructions executable to implement the operation, etc. Reciting that a unit/circuit/component is “configured to” perform one or more tasks is expressly intended not to invoke 35 U.S.C. § 112, sixth paragraph, for that unit/circuit/component. Additionally, “configured to” can include generic structure (e.g., generic circuitry) that is manipulated by software and/or firmware (e.g., an FPGA or a general-purpose processor executing software) to operate in manner that is capable of performing the task(s) at issue. “Configure to” may also include adapting a manufacturing process (e.g., a semiconductor fabrication facility) to fabricate devices (e.g., integrated circuits) that are adapted to implement or perform one or more tasks.

“First,” “Second,” etc. As used herein, these terms are used as labels for nouns that they precede, and do not imply any type of ordering (e.g., spatial, temporal, logical, etc.). For example, a buffer circuit may be described herein as performing write operations for “first” and “second” values. The terms “first” and “second” do not necessarily imply that the first value must be written before the second value.

“Based On.” As used herein, this term is used to describe one or more factors that affect a determination. This term does not foreclose additional factors that may affect a determination. That is, a determination may be solely based on those factors or based, at least in part, on those factors. Consider the phrase “determine a based on B.” While in this case, b is a factor that affects the determination of A, such a phrase does not foreclose the determination of a from also being based on C. In other instances, a may be determined based solely on B.

It will also be understood that, although the terms first, second, etc. may be used herein to describe various elements, these elements should not be limited by these terms. These terms are only used to distinguish one element from another. For example, a first contact could be termed a second contact, and, similarly, a second contact could be termed a first contact, without departing from the intended scope. The first contact and the second contact are both contacts, but they are not the same contact.

The terminology used in the description herein is for the purpose of describing particular embodiments only and is not intended to be limiting. As used in the description and the appended claims, the singular forms “a”, “an” and “the” are intended to include the plural forms as well, unless the context clearly indicates otherwise. It will also be understood that the term "and/or" as used herein refers to and encompasses any and all possible combinations of one or more of the associated listed items. It will be further understood that the terms "includes," "including," "comprises," and/or "comprising," when used in this specification, specify the presence of stated features, integers, steps, operations, elements, and/or components, but do not preclude the presence or addition of one or more other features, integers, steps, operations, elements, components, and/or groups thereof.

As used herein, the term "if" may be construed to mean "when" or "upon" or "in response to determining" or "in response to detecting," depending on the context. Similarly, the phrase "if it is determined" or "if [a stated condition or event] is detected" may be construed to mean "upon determining" or "in response to determining" or "upon detecting [the stated condition or event]" or "in response to detecting [the stated condition or event]," depending on the context.

### DETAILED DESCRIPTION

Various embodiments described herein relate to a variable aperture assemblies, for a camera modules (e.g., small form factor camera modules) that may be positioned over an aperture. The aperture may allow/permit light from an external environment or exterior region (e.g., external to the camera module, from an object-side of an optical assembly along a light path) to pass therethrough to one or more lenses of the camera module and/or an image sensor of the camera module. The variable aperture assembly may change or vary (e.g., modulate) a diameter of the aperture to change an amount of light from the external environment that reaches the lenses and/or the image sensor of the camera module. Conventional variable aperture assemblies generally include voice coil motor (VCM) actuators including one or more magnets adjacent one or more coils to move a rotor relative to a stator to actuate the variable aperture assembly. For example, to actuate a variable aperture assembly with a VCM actuator between a fully open position and a fully actuated position, electric current may be provided to a coil that is within the magnet field of an adjacent magnet to generate Lorentz forces that cause either the magnet (e.g., when the magnet is attached to the rotor) or the coil (e.g., when the coil is attached to the rotor), to move the rotor relative to the stator and actuate the variable aperture assembly.

However, variable aperture assemblies that utilize VCM actuator for actuation between a fully open position and a fully actuated position have several drawbacks. For example, such variable aperture assemblies may be heavy and occupy a lot of space (e.g., a large footprint, a large shoulder height) due to the weight and size of the magnets of the VCM actuators needed for variable aperture assembly actuation. Also, variable aperture assemblies with VCM actuators generally require a significant amount of power to generate sufficiently strong Lorentz forces to drive the actuation of the variable aperture assembly. In addition, VCM actuators may be used to drive other components of the camera module including movement of the lens and/or the image sensor for autofocus (AF) and optical image stabilization (OIS). As a result, the magnets and/or coils of VCM actuators for variable apertures may interfere with the VCM actuators for AF and/or OIS. Even further, VCM actuators may interfere with other system components of the camera module and external to the camera module. Thus, having VCM actuators for the variable aperture assembly in addition to using VCM actuators for other operations of the camera module may create a substantial amount of interference for those other system components and/or for those external components. Also, variable aperture assemblies utilizing VCM actuators may have limited locking and/or holding capabilities for the rotor.

As described herein, a variable aperture assembly, for a camera module (e.g., a small form factor camera module) may include overlapping mechanical blades. For example, a variable aperture assembly for a camera module may be positioned over an aperture for allowing/permitting light to pass therethrough to one or more lenses of the camera module and/or an image sensor of the camera module. The variable aperture assembly may change or vary (e.g., modulate) a diameter of the aperture to change an amount of light that reaches the lenses and/or the image sensor of the camera module. The variable aperture assembly may include a rotor and a stator with an opening therethrough. The opening may be aligned with an optical axis of a camera module. The overlapping mechanical blades may be actuated between and including a fully open position and a fully actuated position.

The variable aperture assembly may be attached to an optical assembly having one or more lenses. For example, the variable aperture assembly may include a variable aperture that is attached to an object side of an optical assembly, an image side of an optical assembly, or between two lenses of an optical assembly. The optical assembly may include one or more actuators to move the optical assembly along the optical axis for autofocus (AF). For example, one or more VCM actuators and/or one or more shape memory alloy (SMA) wire actuators may be configured to move the optical assembly along the optical axis away from an image sensor and towards the image sensor for AF. The variable aperture may include a cam pin and a cam profile. For example, the cam pin may be attached to a rotor of the variable aperture assembly and extend into the cam profile. The cam profile may extend both along the optical axis and at least partially around the optical axis. When the one or more actuators to move the optical assembly along the optical axis for AF are activated, the optical assembly moves along the optical axis for AF. As the optical assembly moves along the optical axis for AF, the cam pin in the cam profile moves within the cam profile following the shape of the cam profile and causes the rotor of the variable aperture assembly to move relative to the stator of the variable aperture assembly creating a torsion load for driving the actuation of the overlapping mechanical blades between and including the fully open position and the fully actuated position. As the overlapping mechanical blades actuate, they extend into the opening of the rotor and stator reducing the diameter of the opening and the aperture and thus reducing the amount of light that pass from the external environment, through the aperture, and to the lenses and/or the image sensor of the camera module.

The direction that the optical assembly moves along the optical axis may determine whether the variable aperture assembly opens (e.g., increases a diameter of the aperture) or closes (e.g., decreases a diameter of the aperture). For example, the cam profile may be configured so that as the optical assembly moves along the optical axis and towards the image sensor, the more the diameter of the aperture increases. As another example, the cam profile may be configured so that as the optical assembly moves along the optical axis and towards the image sensor, the more the diameter of the aperture decreases. As another example, the cam profile may be configured so that as the optical assembly moves along the optical axis and away from the image sensor, the more the diameter of the aperture decreases. As yet another example, the cam profile may be configured so that as the optical assembly moves along the optical axis and away from the image sensor, the more the diameter of the aperture increases.

A distance that the shape of the cam profile forms or extends around the optical axis relative a distance that the shape of the cam profile forms or extends along the optical axis may determine how much or how quickly the variable aperture assembly opens (e.g., increases a diameter of the aperture) or closes (e.g., decreases a diameter of the aperture) as the optical assembly moves along the optical axis. For example, when the cam profile forms or extends around the optical axis sharply per unit distance along the optical axis, the variable aperture assembly opens and closes relatively fast as the optical assembly moves along the optical axis. As another example, when the cam profile forms or extends around the optical axis gradually per unit distance along the optical axis, the variable aperture assembly opens and closes relatively slow as the optical assembly moves along the optical axis.

Using the optical assembly AF actuator and a cam pin attached to the rotor of the variable aperture and extend into a cam profile rather than a separate actuator to actuate the variable aperture assembly and specifically the overlapping mechanical blades mitigates problems associated with a separate actuator. For example, variable aperture assemblies that utilize AF actuators for actuating the overlapping mechanical blades may be lighter and occupy less space (e.g., a smaller footprint, a smaller shoulder height) compared variable aperture assemblies that have their own actuators due to additional parts/components needs for the additional actuator. Also, compared to variable aperture assemblies that have their own actuators, variable aperture assemblies that rely on an AF actuator (e.g., or another actuator, a shared actuator) may require less power to generate forces for two separate actuators. In addition, compared to variable aperture assemblies that utilize their own VCM actuators, a variable aperture assembly that relies on the AF VCM actuators may not produce as many electric fields and magnetic fields and thus may not create as much interference with other components and functions of the camera module including movement of the lens and/or the image sensor for autofocus (AF) and optical image stabilization (OIS). Even further, compared to variable aperture assemblies that utilize their own VCM actuators, a variable aperture assembly that relies on the AF VCM actuators may not interfere with other system components of the camera module and external to the camera module. Thus, having a variable aperture assembly that relies on an AF actuator for movement, rather than a variable aperture assembly with its own actuators, may reduce the amount of interference for those other system components and/or for those external components.

Reference will now be made in detail to embodiments, examples of which are illustrated in the accompanying drawings. In the following detailed description, numerous specific details are set forth in order to provide a thorough understanding of the present disclosure. However, it will be apparent to one of ordinary skill in the art that some embodiments may be practiced without these specific details. In other instances, well-known methods, procedures, components, circuits, and networks have not been described in detail so as not to unnecessarily obscure aspects of the embodiments.

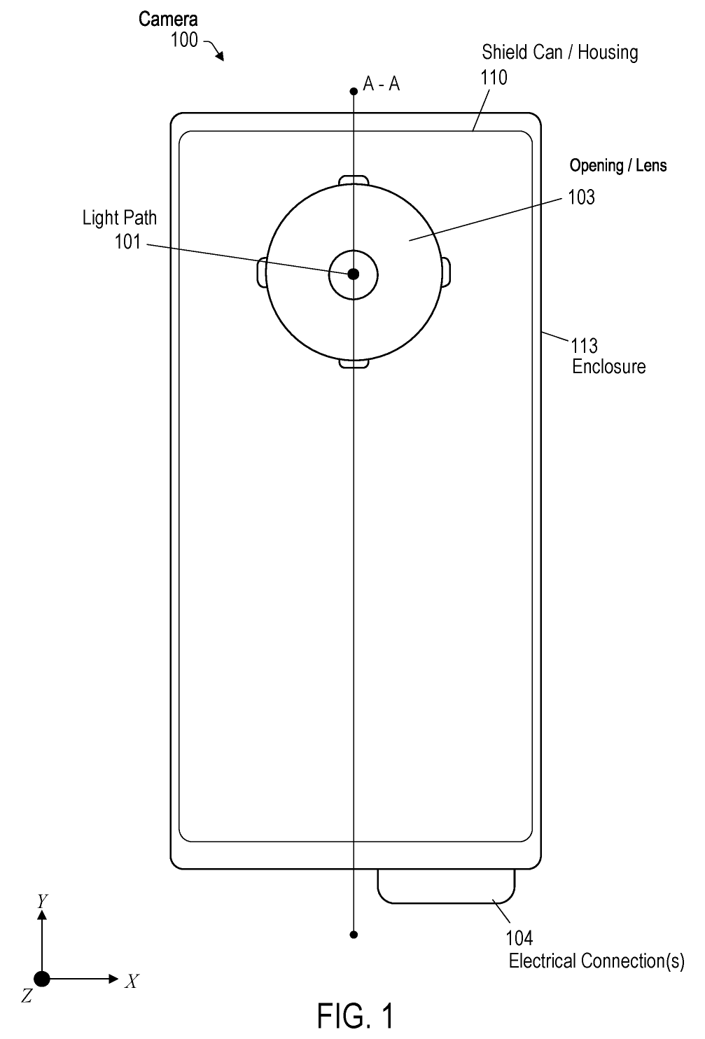

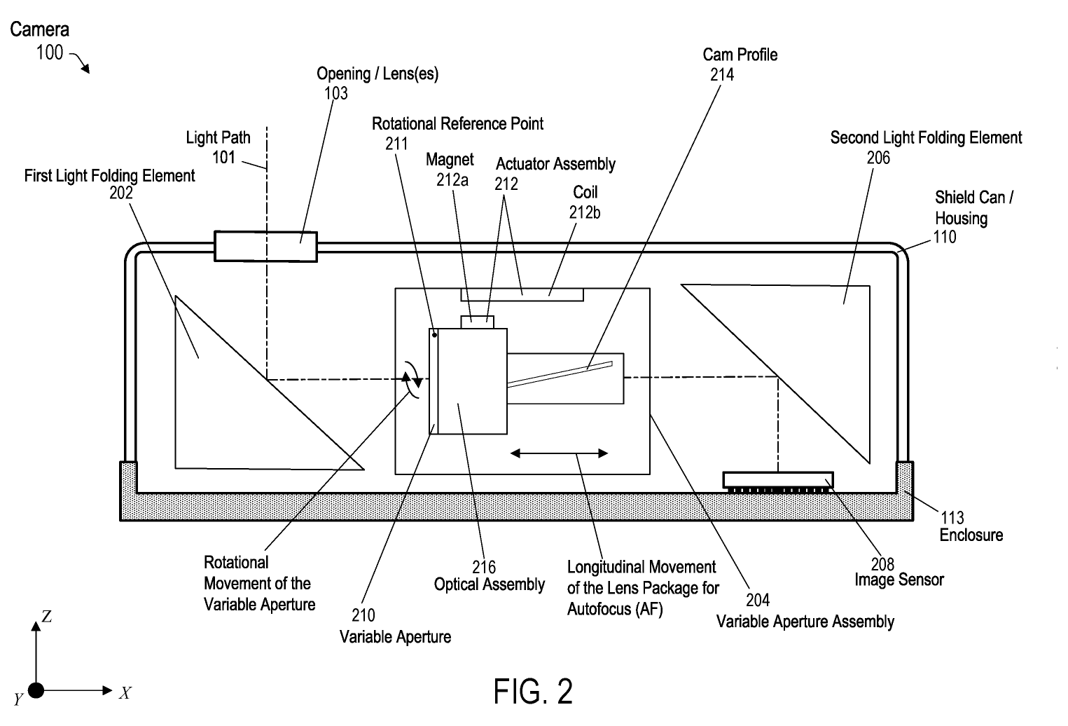

FIG. 1 illustrates components of an example camera 100 having a variable aperture assembly that may, for example, change the diameter of an aperture/opening to change an amount of light that reaches lenses of an optical assembly and/or an image sensor in small form factor cameras, according to at least some embodiments. FIG. 1 shows an overhead view of the exterior of the camera 100. The camera 100 of FIG. 1 may include one or more same or similar features as the features described with respect to or illustrated in FIGS. 2, 3, 4, 5, 6, 7, 8A, 8B, 8C, 8D, 9A, 9B, 9C, 9D, 10, 11, 12, and 13. The example X-Y-Z coordinate system shown in FIG. 1 may be used to discuss aspects of components and/or systems, and may apply to embodiments described throughout this disclosure.

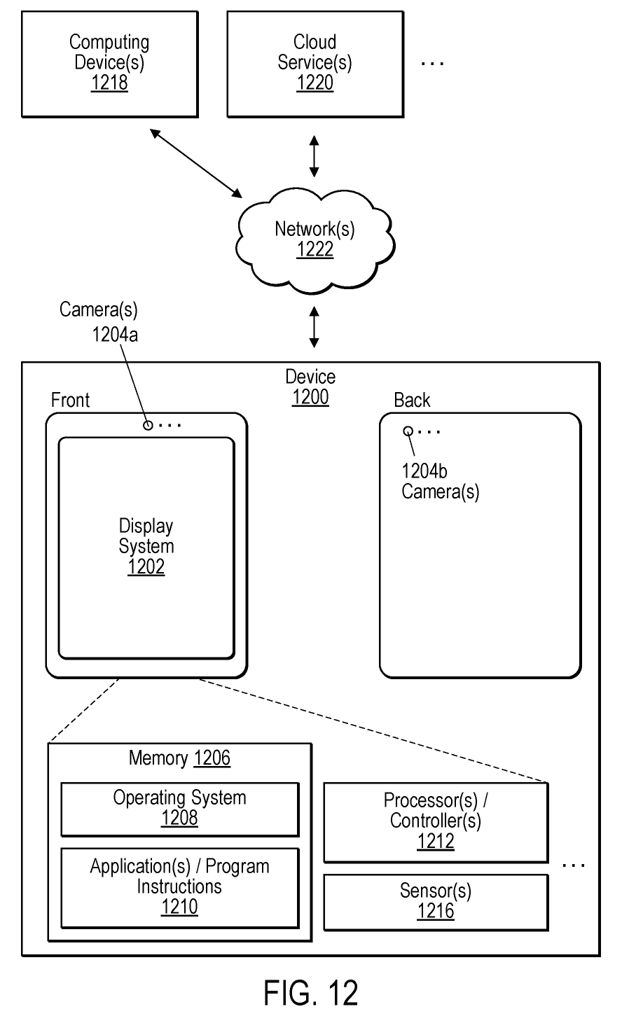

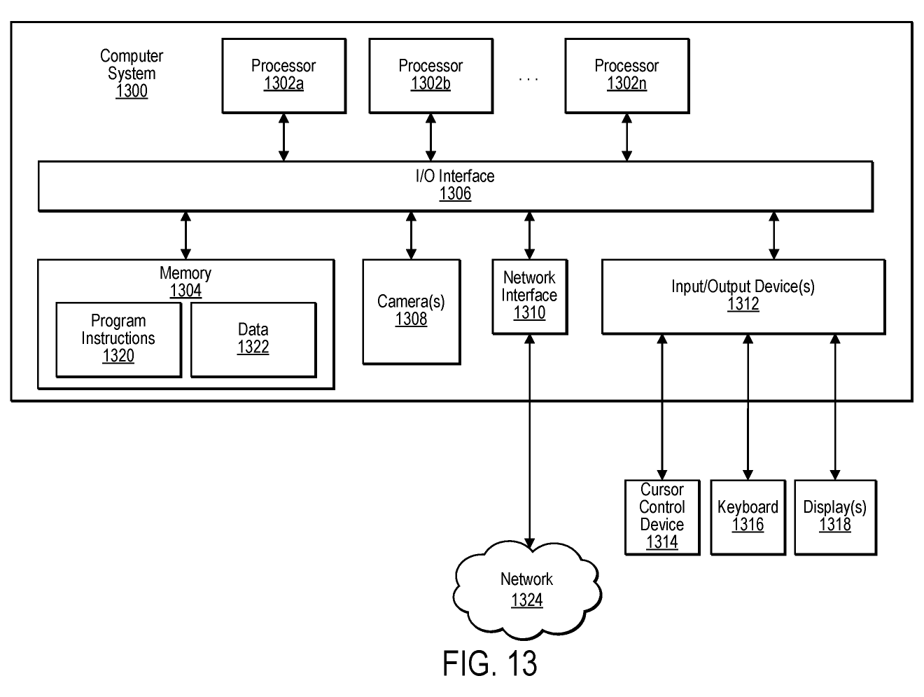

In various embodiments, the camera 100 may include an opening / lens(es) 103 defining a light path 101 (e.g., including an optical axis), a shield can or housing 110, an enclosure or base 113, and electrical connection(s) 104. The shield can 110 may form an outer wall of a top portion (and in some cases side portions) of the camera 100 and form one or more camera shoulders. The enclosure 113 may form an outer wall of a bottom portion (and in some cases side portion(s)) of the camera 100. The electrical connection(s) 104 may extend from the enclosure 113 (and/or the shield can 110) and may electrically connect the camera 100 to an external device. For example, the camera 100 may be the same or similar camera as the camera 1204b illustrated in FIG. 12 or the camera 1308 illustrated in FIG. 13. As such, the electrical connection(s) 104 may extend from the enclosure 113 and may electrically connected the camera 100 to the device 1200 illustrated in FIG. 12 or the computer system 1300 illustrated in FIG. 13, respectively.

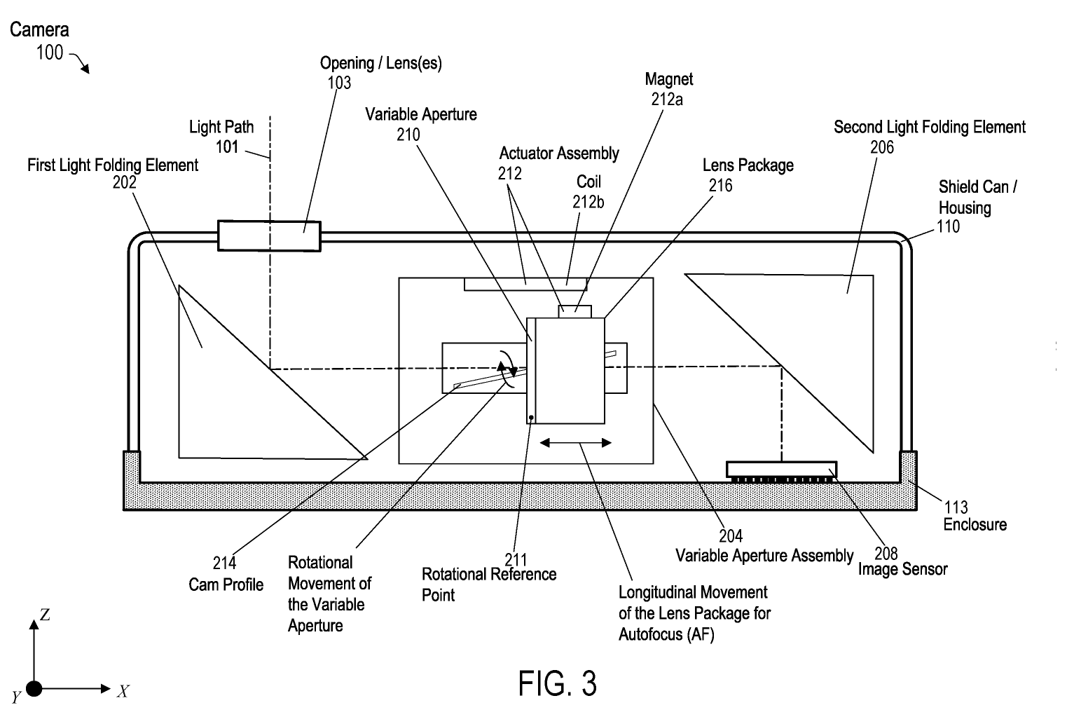

FIGS. 2 and 3 illustrate components of an example camera 100 having a variable aperture assembly 204 that may, for example, change the diameter of an aperture/opening to change an amount of light that reaches lenses of an optical assembly and/or an image sensor in small form factor cameras, according to at least some embodiments. FIG. 2 shows a cross-sectional view of the camera with the variable aperture assembly in a first position. FIG. 3 shows a cross-sectional view of the camera 100 with the variable aperture assembly 204 in a second position. The camera 100 of FIGS. 2 and 3 may include one or more same or similar features as the features described with respect to or illustrated in FIGS. 1, 4, 5, 6, 7, 8A, 8B, 8C, 8D, 9A, 9B, 9C, 9D, 10, 11, 12, and 13. The example X-Y-Z coordinate system shown in FIGS. 2 and 3 may be used to discuss aspects of components and/or systems, and may apply to embodiments described throughout this disclosure.

As shown in FIGS. 2 and 3, the camera 100 may include the shield can / housing 110, the enclosure 113, the opening / lenses 103, a first light folding element 202, a variable aperture assembly 204, a second light folding element 206, and an image sensor 208. A light path 101 may extend from an environment exterior to the camera 100, through the opening / lens(es) 103, reflect off the first light folding element 202 (e.g., change direction 90 degrees), extend through the variable aperture assembly 204 including the variable aperture 210 and the optical assembly 216, reflect off the second light folding element 206, and reach the image sensor 208. It should be understood that the light path 101 extending through the variable aperture assembly 204 including the variable aperture 210 and the optical assembly 216 and between the first light folding element 202 and the second light folding element 206 may be considered an optical axis.

The variable aperture assembly 204 may be positioned along the light path 101 between the first light folding element 202 and the second light folding element 206. The variable aperture assembly 204 may include the optical assembly 216, an AF actuator assembly 212, a variable aperture 210, and a cam profile 214. As shown in FIGS. 2 and 3, the AF actuator assembly 212 may include a magnet 212a attached to the moving optical assembly 216 a coil 212b attached to a stationary component of the variable aperture assembly 204 or a stationary component of the camera 100. A magnetic field from the magnets 212a may interact with current flowing through the coils 212b creating Lorentz forces to move the optical assembly 216 and the variable aperture 210 in one or more directions along the light path 101 (e.g., along the optical axis) for AF.

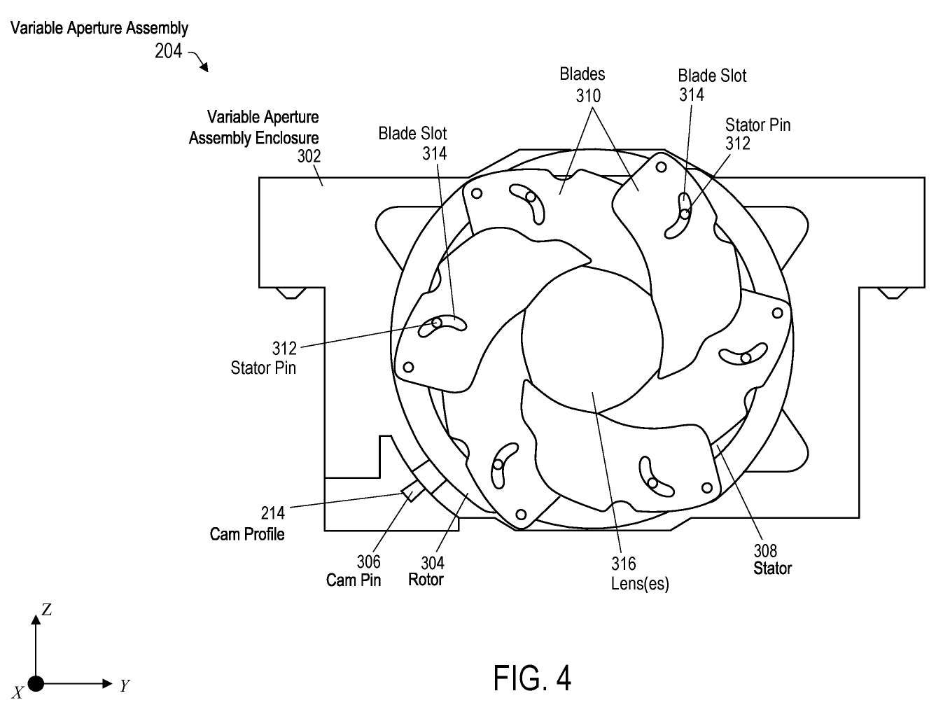

As described herein, the variable aperture 210 may include a cam pin (e.g., cam pin 306 illustrated in FIG. 4) and a cam profile 214. For example, the cam pin may be attached to a rotor of the variable aperture assembly 204 (e.g., the variable aperture 210) and extend into the cam profile 214. The cam profile 214 may extend both along the optical axis or light path 101 and at least partially around the optical axis or light path 101. When the AF actuators assembly 212 to move the optical assembly 216 along the optical axis or light path 101 for AF is activated, the optical assembly 216 moves along the optical axis or light path 101 for AF. As the optical assembly 216 moves along the optical axis or light path 101 for AF, the cam pin in the cam profile 214 moves within the cam profile 214 following the shape of the cam profile 214 and causes the rotor of the variable aperture 210 or of the variable aperture assembly 204 to move relative to the stator of the variable aperture 210 of the variable aperture assembly 204 creating a torsion load for driving the actuation of the overlapping mechanical blades between and including the fully open position and the fully actuated position. As the overlapping mechanical blades actuate, they extend into the opening of the rotor and stator reducing the diameter of the opening and the variable aperture 210 and thus reducing the amount of light that passes through the variable aperture 210 and to the lenses of the optical assembly 216 and/or the image sensor 208 of the camera 100.

For example, as shown in FIG. 2, the optical assembly 216 and the variable aperture 210 may be positioned at a furthest position along the light path 101 from the image sensor 208 (e.g., nearest to the first light folding element 202, furthest from the second light folding element 206). A rotational reference point 211 may indicate that the variable aperture 210 is in a first rotation position, for example, such that the variable aperture 210 has a minimum diameter. As shown in FIG. 3, the optical assembly 216 and the variable aperture 210 may be positioned at a nearer position along the light path 101 to the image sensor 208 (e.g., nearer to the second light folding element 206). The rotational reference point 211 may indicate that the variable aperture 210 is in a second rotation position, for example, such that the variable aperture 210 has a changed from the minimum diameter to a larger diameter.

FIG. 4 illustrates components of an example variable aperture assembly 204 that may, for example, change the diameter of an aperture/opening to change an amount of light that reaches lenses of an optical assembly and/or an image sensor in small form factor cameras, according to at least some embodiments. FIG. 4 shows an overhead view of the variable aperture assembly 204. The variable aperture assembly 204 of FIG. 4 may include one or more same or similar features as the features described with respect to or illustrated in FIGS. 1, 2, 3, 5, 6, 7, 8A, 8B, 8C, 8D, 9A, 9B, 9C, 9D, 10, 11, 12, and 13. The example X-Y-Z coordinate system shown in FIG. 4 may be used to discuss aspects of components and/or systems, and may apply to embodiments described throughout this disclosure.

As shown in FIG. 4, the variable aperture 210 may include a variable aperture assembly enclosure 302, a rotor 304, a stator 308, a plurality of blades 310, a plurality of stator pins 312 extend from the stator 308, a plurality of blade slots 314 receiving respective stator pins 312, a cam pin 306 attached to the rotor 304, and a cam profile 214. When the rotor 304 rotates relative to the stator 308, each of the blades 310 attached to the rotor 304 move along the direction form by the blade slots 314 based on the stator pins 312 attached to the stator 308 and extending through the blade slots 314. Accordingly, moving the rotor 304 in a first direction relative to the stator 308 causes the blades 310 to all extend towards the center of the variable aperture 210. Similarly, moving the rotor 304 in a second direction, opposite the first direction, relative to the stator 308 causes the blades 310 to all retract from the center of the variable aperture 210.

Because the variable aperture 210 is attached to the optical assembly 216 and because the cam pin 306 is attached to the rotor 304, as the cam pin 306 positioned within the cam profile 214 may cause rotation of the rotor 304 relative to the stator 308 as the optical assembly 216 and variable aperture 210 move along the light path 101 for AF. For example, the cam profile 214 may be formed in the static component of the camera 100 so that the variable aperture assembly enclosure 302 moves with the optical assembly 216 and the variable aperture 210. The cam profile 214 may extend both along the light path 101 and at least partially around the light path 101. When the AF actuators assembly 212 to move the optical assembly 216 along the optical axis or light path 101 for AF is activated, the optical assembly 216 moves along the light path 101 for AF. As the optical assembly 216 moves along the light path 101 for AF in a first direction, the cam pin in the cam profile 214 moves within the cam profile 214 following the shape of the cam profile 214 and causes the rotor of the variable aperture 210 or of the variable aperture assembly 204 to move relative to the stator of the variable aperture 210 of the variable aperture assembly 204 creating a torsion load for driving the actuation of the overlapping mechanical blades 310 between and including the fully open position and the fully actuated position. As the overlapping mechanical blades 310 actuate, they extend into the opening of the rotor 304 and stator 308 reducing the diameter of the opening and the variable aperture 210 and thus reducing the amount of light that passes through the variable aperture 210 and to the lenses of the optical assembly 216 and/or the image sensor 208 of the camera 100. As the optical assembly 216 moves along the light path 101 for AF in a second direction, opposite the first direction, the cam pin in the cam profile 214 moves within the cam profile 214 following the shape of the cam profile 214 and causes the rotor of the variable aperture 210 or of the variable aperture assembly 204 to move relative to the stator of the variable aperture 210 of the variable aperture assembly 204 creating a torsion load for driving the actuation of the overlapping mechanical blades 310 between and including the fully open position and the fully actuated position. As the overlapping mechanical blades 310 actuate, they retrack from the opening of the rotor 304 and stator 308 reducing the diameter of the opening and the variable aperture 210 and thus reducing the amount of light that passes through the variable aperture 210 and to the lenses of the optical assembly 216 and/or the image sensor 208 of the camera 100.

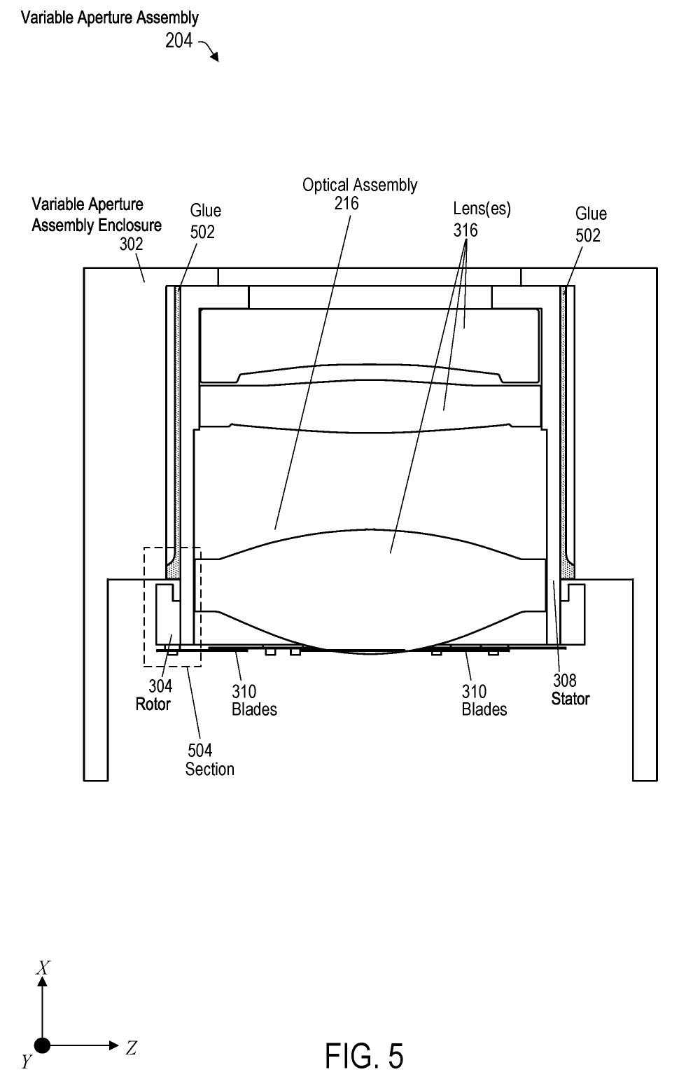

FIG. 5 illustrates components of an example variable aperture assembly 204 that may, for example, change the diameter of an aperture/opening to change an amount of light that reaches lenses of an optical assembly and/or an image sensor in small form factor cameras, according to at least some embodiments. FIG. 5 shows a cross-sectional view of the variable aperture assembly 204. The variable aperture assembly 204 of FIG. 5 may include one or more same or similar features as the features described with respect to or illustrated in FIGS. 1, 2, 3, 4, 6, 7, 8A, 8B, 8C, 8D, 9A, 9B, 9C, 9D, 10, 11, 12, and 13. The example X-Y-Z coordinate system shown in FIG. 5 may be used to discuss aspects of components and/or systems, and may apply to embodiments described throughout this disclosure.

As shown in FIG. 5, the variable aperture 210 may include a variable aperture assembly enclosure 302, a rotor 304, a stator 308, a plurality of blades 310, the optical assembly 216. The optical assembly 216 may include a plurality of lenses 316. As shown in FIG. 5, the stator 308 may be fixedly attached to the variable aperture assembly enclosure 302 via a glue 502. Thus, the variable aperture assembly enclosure 302 may move along the light path 101 during AF movement of the optical assembly 216 and the variable aperture 210. When the rotor 304 rotates relative to the stator 308, each of the blades 310 attached to the rotor 304 move to open or close the variable aperture 210. Accordingly, moving the rotor 304 in a first direction relative to the stator 308 causes the blades 310 to all extend towards the center of the variable aperture 210 closing the variable aperture 210 (e.g., decreasing the diameter of the variable aperture 210). Similarly, moving the rotor 304 in a second direction, opposite the first direction, relative to the stator 308 causes the blades 310 to all retract from the center of the variable aperture 210 opening the variable aperture 210 (e.g., increasing the diameter of the variable aperture 210).

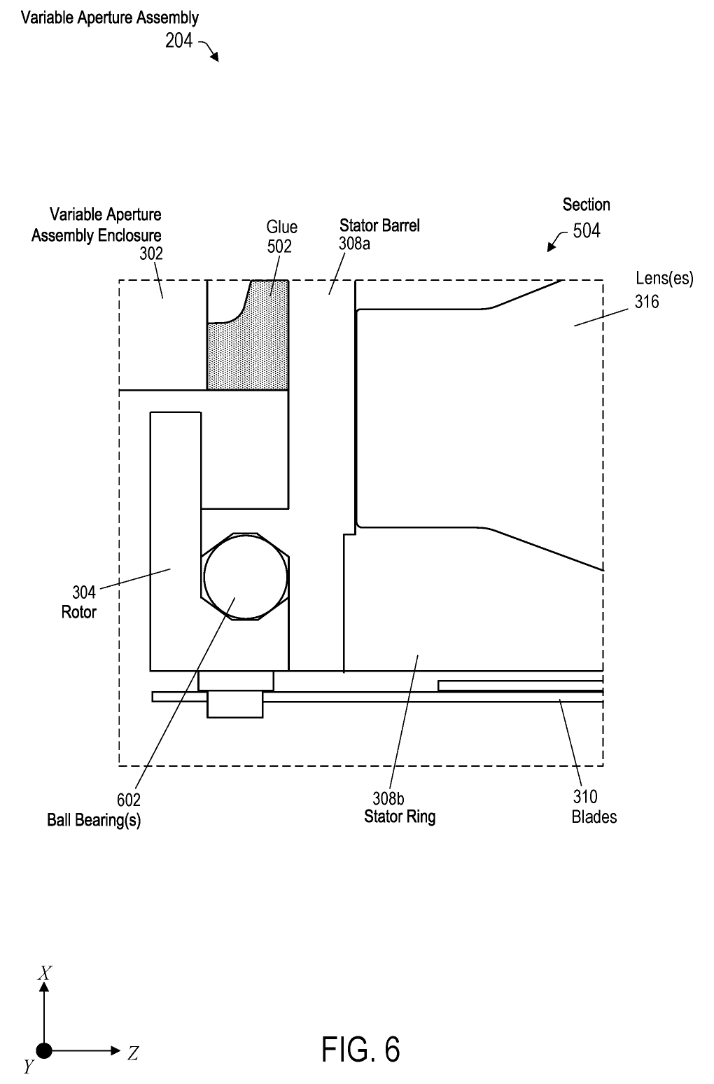

FIG. 6 illustrates components of an example variable aperture assembly 204 that may, for example, change the diameter of an aperture/opening to change an amount of light that reaches lenses of an optical assembly and/or an image sensor in small form factor cameras, according to at least some embodiments. FIG. 6 shows a cross-sectional view of a section 504 of the variable aperture assembly 204 illustrated in FIG. 5. The section of the variable aperture assembly 204 of FIG. 6 may include one or more same or similar features as the features described with respect to or illustrated in FIGS. 1, 2, 3, 4, 5, 7, 8A, 8B, 8C, 8D, 9A, 9B, 9C, 9D, 10, 11, 12, and 13. The example X-Y-Z coordinate system shown in FIG. 6 may be used to discuss aspects of components and/or systems, and may apply to embodiments described throughout this disclosure.

A shown in FIG. 6, the section 504 of the variable aperture assembly 204 includes the rotor 304, the stator 308 including the stator barrel 308a and the stator ring 308b, ball bearings 602, the variable aperture assembly enclosure 302, the glue 502, the optical assembly 216 including the lenses 316, and the blades 310. The ball bearings 602 between the rotor 304 and the stator 308 may allow for motion of the rotor 304 relative to the stator 308. In some aspects, the stator 308 may include a magnet that attracts the rotor 304 to the stator 308 holding the ball bearings 602 in place. Also, the glue 502 holds the stator barrel 308a of the stator 308 to the variable aperture assembly enclosure 302. The blades 310 may move with the rotor 304 and relative to the stator 308 including the stator ring 308b to change the diameter of the variable aperture 210.

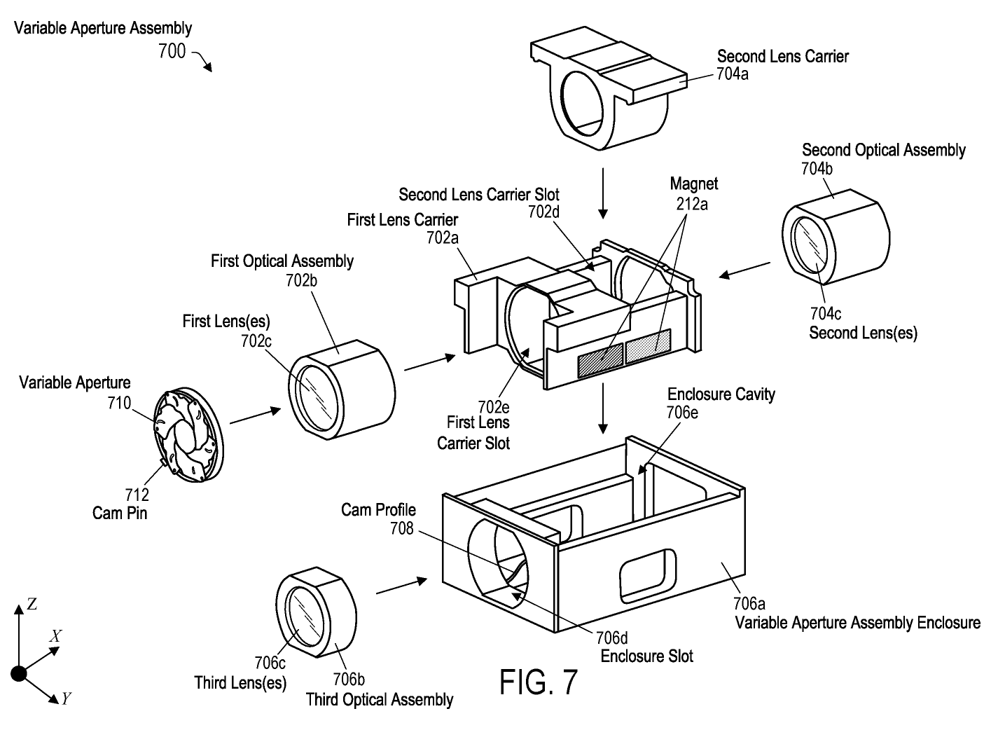

FIG. 7 illustrates components of an example variable aperture assembly 700 that may, for example, change the diameter of an aperture/opening to change an amount of light that reaches lenses of an optical assembly and/or an image sensor in small form factor cameras, according to at least some embodiments. FIG. 7 shows an exploded view of the variable aperture assembly 700. The variable aperture assembly 700 of FIG. 7 may include one or more same or similar features as the features described with respect to or illustrated in FIGS. 1, 2, 3, 4, 5, 6, 8A, 8B, 8C, 8D, 9A, 9B, 9C, 9D, 10, 11, 12, and 13. The example X-Y-Z coordinate system shown in FIG. 7 may be used to discuss aspects of components and/or systems, and may apply to embodiments described throughout this disclosure.

As shown in FIG. 7, the variable aperture assembly 700 may include a first optical assembly 702b and a second optical assembly 704b. The first optical assembly 702b may include one or more first lenses 702c and may fit within the first lens carrier slot 702e of the first lens carrier 702a. The variable aperture 710 may be positioned on a side of the first optical assembly 702b and/or a side of the first lens carrier 702a. The second optical assembly 704b may include one or more second lenses 704c and may be retained within a second lens carrier 704a. The second lens carrier 704a may be positioned in the second lens carrier slot 702d of the first lens carrier 702a. When the variable aperture 710 is positioned on a side of the first optical assembly 702b and/or a first side of the first lens carrier 702a and the first optical assembly 702b and the second optical assembly 704b are positioned within the first lens carrier 702a, the first lens carrier 702a may be positioned in an enclosure cavity 706e within the variable aperture assembly enclosure 706a. A third optical assembly 706b having one or more third lenses 70c may be positioned within an enclosure slot 706d of the variable aperture assembly enclosure 706a. The variable aperture assembly enclosure 706a may also include a window so that when variable aperture 710 is positioned within the variable aperture enclosure 706a, the cam pin 712 may extend in a cam profile 708. Thus, when the variable aperture assembly enclosure 706a moves along an axis or a light path, the cam pin 712 of the variable aperture 710 may engage with the cam profile 708 casing the variable aperture assembly to rotate and change a diameter of the variable aperture 710.

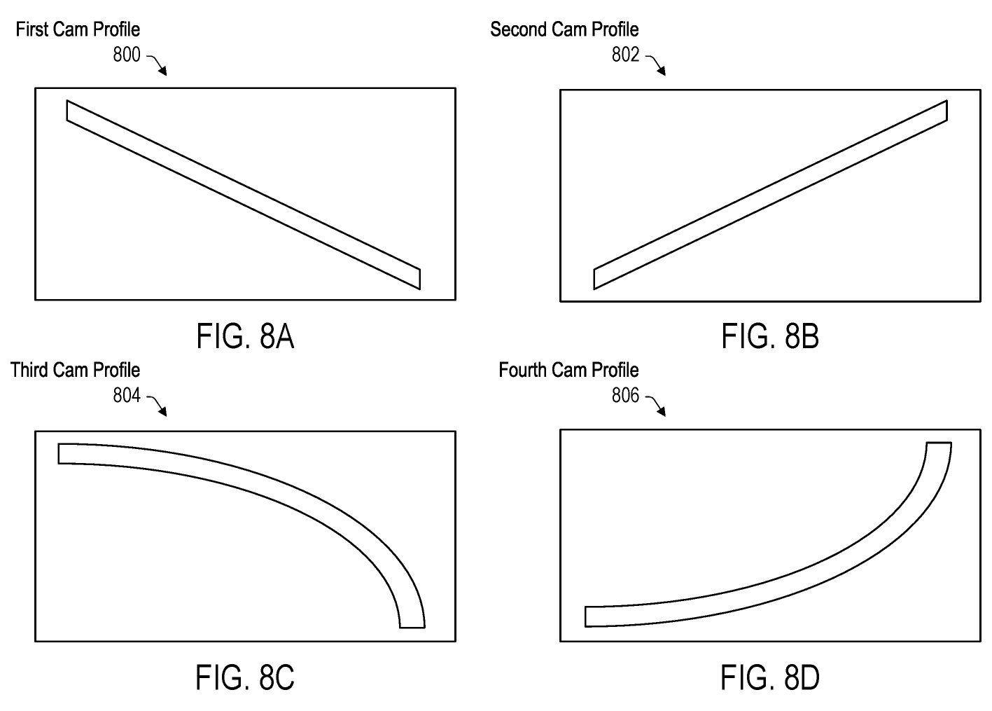

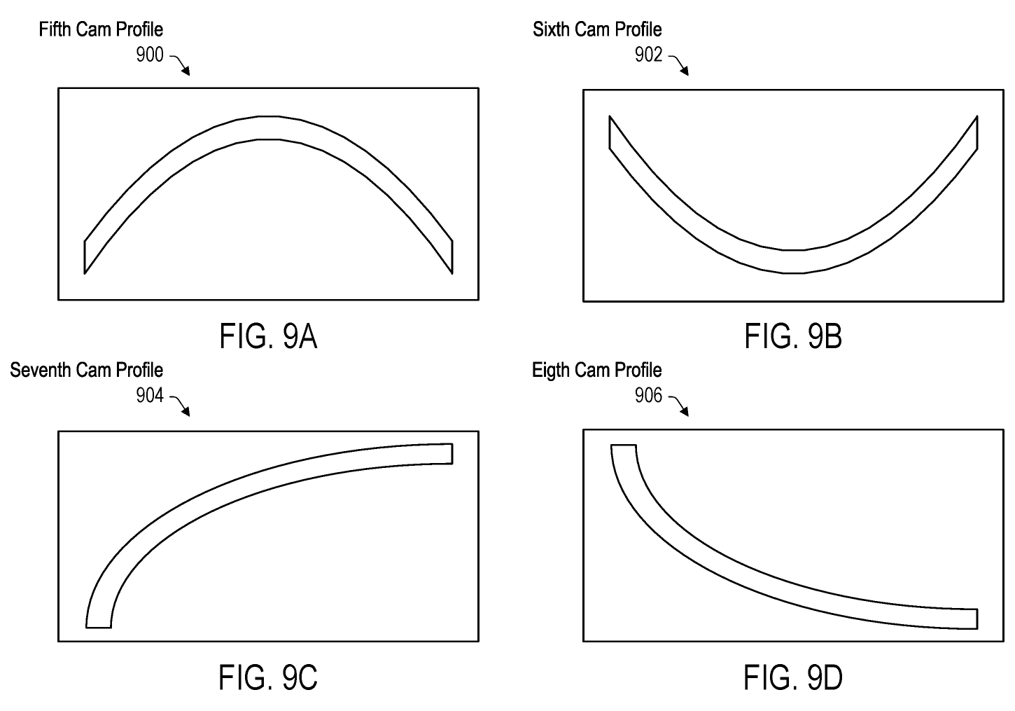

FIGS. 8A, 8B, 8C, 8D, 9A, 9B, 9C, and 9D illustrates components of example variable aperture assemblies that may, for example, change the diameter of an aperture/opening to change an amount of light that reaches lenses of an optical assembly and/or an image sensor in small form factor cameras, according to at least some embodiments. FIG. 8A shows perspective view of a first cam profile of a variable aperture assembly. FIG. 8B shows perspective view of a second cam profile of a variable aperture assembly. FIG. 8C shows perspective view of a third cam profile of a variable aperture assembly. FIG. 8D shows perspective view of a fourth cam profile of a variable aperture assembly. FIG. 9A shows perspective view of a fifth cam profile of a variable aperture assembly. FIG. 9B shows perspective view of a sixth cam profile of a variable aperture assembly. FIG. 9C shows perspective view of a seventh cam profile of a variable aperture assembly. FIG. 9D shows perspective view of an eighth cam profile of a variable aperture assembly. The cam profiles of FIGS. 8A, 8B, 8C, 8D, 9A, 9B, 9C, and 9B may include one or more same or similar features as the features described with respect to or illustrated in FIGS. 1, 2, 3, 4, 5, 6, 7, 10, 11, 12, and 13.

As described herein, the direction that the optical assembly 216 moves along the optical axis or the light path 101 may determine whether the variable aperture assembly opens (e.g., increases a diameter of the aperture) or closes (e.g., decreases a diameter of the aperture). For example, the cam profile may be configured so that as the optical assembly 216 moves along the optical axis and towards the image sensor, the more the diameter of the variable aperture 210 increases. As another example, the cam profile may be configured so that as the optical assembly 216 moves along the optical axis or the light path 101 and towards the image sensor 208, the more the diameter of the variable aperture decreases. As another example, the cam profile may be configured so that as the optical assembly 216 moves along the optical axis or the light path 101 and away from the image sensor 208, the more the diameter of the variable aperture 210 decreases. As yet another example, the cam profile may be configured so that as the optical assembly 216 moves along the optical axis or the light path 101 and away from the image sensor 208, the more the diameter of the variable aperture 210 increases.

In addition, as described herein, a distance that the shape of the cam profile forms or extends around the optical axis or light path 101 relative a distance that the shape of the cam profile forms or extends along the optical axis or the light path 101 may determine how much or how quickly the variable aperture 210 opens (e.g., increases a diameter of the aperture) or closes (e.g., decreases a diameter of the aperture) as the optical assembly 216 moves along the optical axis or light path 101. For example, when the cam profile forms or extends around the optical axis or light path 101 sharply per unit distance along the optical axis or light path 101, the variable aperture 210 opens and closes relatively fast as the optical assembly 216 moves along the optical axis or light path 101. As another example, when the cam profile forms or extends around the optical axis or light path 101 gradually per unit distance along the optical axis or light path 101, the variable aperture opens and closes relatively slow as the optical assembly 216 moves along the optical axis or the light path.

As shown in FIG. 8A, the first cam profile 800 includes a linear and negative or downward slope. Thus, as the optical assembly 216 moves along the light path 101 in a first direction, the cam profile 800 may cause the variable aperture to close at a same rate as the rate of the movement of the optical assembly 216. Similarly, as the optical assembly 216 moves along the light path 101 in a second direction, opposite the first direction, the cam profile 800 may cause the variable aperture to open at a same rate as the rate of the movement of the optical assembly 216.

As shown in FIG. 8B, the second cam profile 802 includes a linear and positive or upward slope. Thus, as the optical assembly 216 moves along the light path 101 in a first direction, the second cam profile 802 may cause the variable aperture 210 to open at a same rate as the rate of the movement of the optical assembly 216. Similarly, as the optical assembly 216 moves along the light path 101 in a second direction, opposite the first direction, the second cam profile 802 may cause the variable aperture 210 to close at a same rate as the rate of the movement of the optical assembly 216.

As shown in FIG. 8C, the third cam profile 804 includes a curved profile and negative or downward curvature. Thus, as the optical assembly 216 moves along the light path 101 in a first direction, the third cam profile 804 may cause the variable aperture 210 to close at an increasing slower rate relative to the rate of the movement of the optical assembly 216. Similarly, as the optical assembly 216 moves along the light path 101 in a second direction, opposite the first direction, the third cam profile 804 may cause the variable aperture 210 to open at an increasingly faster rate relative to the rate of the movement of the optical assembly 216.

As shown in FIG. 8D, the fourth cam profile 806 includes a curved profile and positive or upward curvature. Thus, as the optical assembly 216 moves along the light path 101 in a first direction, the fourth cam profile 806 may cause the variable aperture 210 to close at an increasing faster rate relative to the rate of the movement of the optical assembly 216. Similarly, as the optical assembly 216 moves along the light path 101 in a second direction, opposite the first direction, the fourth cam profile 806 may cause the variable aperture 210 to open at an increasingly slower rate relative to the rate of the movement of the optical assembly 216.

As shown in FIG. 9A, the fifth cam profile 900 includes a curved profile with a maximum or upward point in the middle of the fifth cam profile 900. Thus, as the optical assembly 216 moves along the light path 101 in a first direction, the fifth cam profile 900 may cause the variable aperture to initially close until the optically assembly 216 reaches a midpoint along the light path 101. After the optical assembly 216 reaches the midpoint of the light path 101, the fifth cam profile 900 may cause the variable aperture 210 to begin to open again as it continues in the first direction. Similarly, as the optical assembly 216 moves along the light path 101 in a second direction, opposite the first direction, the fifth cam profile 900 may cause the variable aperture to initially open until the optically assembly 216 reaches the midpoint along the light path 101. After the optical assembly 216 reaches the midpoint of the light path 101, the fifth cam profile 900 may cause the variable aperture 210 to begin to close again as it continues in the second direction.

As shown in FIG. 9B, the sixth cam profile 902 includes a curved profile with a minimum or downward point in the middle of the sixth cam profile 902. Thus, as the optical assembly 216 moves along the light path 101 in a first direction, the sixth cam profile 902 may cause the variable aperture to initially open until the optically assembly 216 reaches a midpoint along the light path 101. After the optical assembly 216 reaches the midpoint of the light path 101, the sixth cam profile 902 may cause the variable aperture 210 to begin to close again as it continues in the first direction. Similarly, as the optical assembly 216 moves along the light path 101 in a second direction, opposite the first direction, the sixth cam profile 902 may cause the variable aperture 210 to initially close until the optically assembly 216 reaches the midpoint along the light path 101. After the optical assembly 216 reaches the midpoint of the light path 101, the sixth cam profile 902 may cause the variable aperture 210 to begin to open again as it continues in the second direction.

As shown in FIG. 9C, the seventh cam profile 904 includes a curved profile and positive or upward curvature. Thus, as the optical assembly 216 moves along the light path 101 in a first direction, the seventh cam profile 904 may cause the variable aperture to open at an increasing slower rate relative to the rate of the movement of the optical assembly 216. Similarly, as the optical assembly 216 moves along the light path 101 in a second direction, opposite the first direction, the seventh cam profile 904 may cause the variable aperture to close at an increasingly faster rate relative to the rate of the movement of the optical assembly 216.

As shown in FIG. 9D, the eighth cam profile 906 includes a curved profile and negative or downward curvature. Thus, as the optical assembly 216 moves along the light path 101 in a first direction, the eighth cam profile 906 may cause the variable aperture 210 to close at an increasing slower rate relative to the rate of the movement of the optical assembly 216. Similarly, as the optical assembly 216 moves along the light path 101 in a second direction, opposite the first direction, the eighth cam profile 906 may cause the variable aperture 210 to open at an increasingly faster rate relative to the rate of the movement of the optical assembly 216.

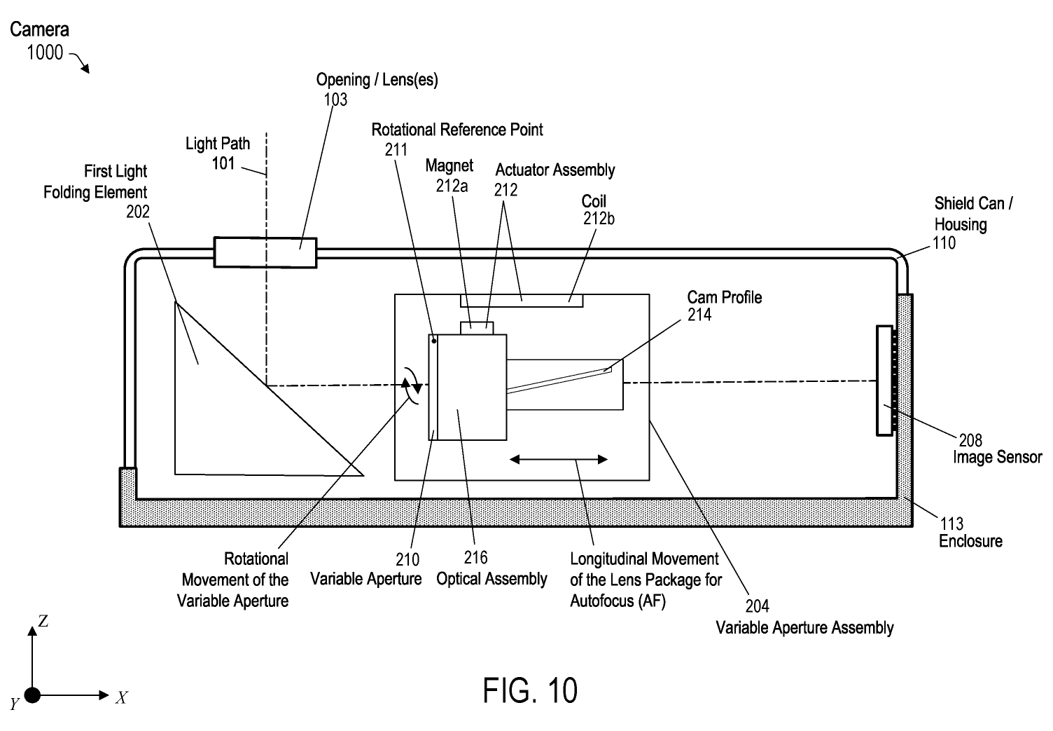

FIG. 10 illustrates components of an example camera 1000 having a variable aperture assembly 204 that may, for example, change the diameter of an aperture/opening to change an amount of light that reaches lenses of an optical assembly and/or an image sensor in small form factor cameras, according to at least some embodiments. FIG. 10 shows a cross-sectional view of the camera 1000 with the variable aperture assembly. The variable aperture assembly 204 of FIG. 10 may include one or more same or similar features as the features described with respect to or illustrated in FIGS. 1, 2, 3, 4, 5, 6, 7, 8A, 8B, 8C, 8D, 9A, 9B, 9C, 9D, 11, 12, and 13. The example X-Y-Z coordinate system shown in FIG. 10 may be used to discuss aspects of components and/or systems, and may apply to embodiments described throughout this disclosure.

As shown in FIG. 10, the camera 1000 may include the shield can / housing 110, the enclosure 113, the opening / lenses 103, a first light folding element 202, a variable aperture assembly 204, and an image sensor 208. A light path 101 may extend from an environment exterior to the camera 1000, through the opening / lens(es) 103, reflect off the first light folding element 202 (e.g., change direction 90 degrees), extend through the variable aperture assembly 204 including the variable aperture 210 and the optical assembly 216, and reach the image sensor 208. It should be understood that the light path 101 extending through the variable aperture assembly 204 including the variable aperture 210 and the optical assembly 216 and between the first light folding element 202 and the image sensor 208 may be considered an optical axis.

The variable aperture assembly 204 may be positioned along the light path 101 between the first light folding element 202 and the image sensor 208. The variable aperture assembly 204 may include the optical assembly 216, an AF actuator assembly 212, a variable aperture 210, and a cam profile 214. As shown in FIG. 10, the AF actuator assembly 212 may include a magnet 212a attached to the moving optical assembly 216 a coil 212b attached to a stationary component of the variable aperture assembly 204 or a stationary component of the camera 100. A magnetic field from the magnets 212a may interact with current flowing through the coils 212b creating Lorentz forces to move the optical assembly 216 and the variable aperture 210 in one or more directions along the light path 101 (e.g., along the optical axis) for AF.

As described herein, the variable aperture 210 may include a cam pin (e.g., cam pin 306 illustrated in FIG. 4) and a cam profile 214. For example, the cam pin may be attached to a rotor of the variable aperture assembly 204 (e.g., the variable aperture 210) and extend into the cam profile 214. The cam profile 214 may extend both along the optical axis or light path 101 and at least partially around the optical axis or light path 101. When the AF actuators assembly 212 to move the optical assembly 216 along the optical axis or light path 101 for AF is activated, the optical assembly 216 moves along the optical axis or light path 101 for AF. As the optical assembly 216 moves along the optical axis or light path 101 for AF, the cam pin in the cam profile 214 moves within the cam profile 214 following the shape of the cam profile 214 and causes the rotor of the variable aperture 210 or of the variable aperture assembly 204 to move relative to the stator of the variable aperture 210 of the variable aperture assembly 204 creating a torsion load for driving the actuation of the overlapping mechanical blades between and including the fully open position and the fully actuated position. As the overlapping mechanical blades actuate, they extend into the opening of the rotor and stator reducing the diameter of the opening and the variable aperture 210 and thus reducing the amount of light that passes through the variable aperture 210 and to the lenses of the optical assembly 216 and/or the image sensor 208 of the camera 1000.

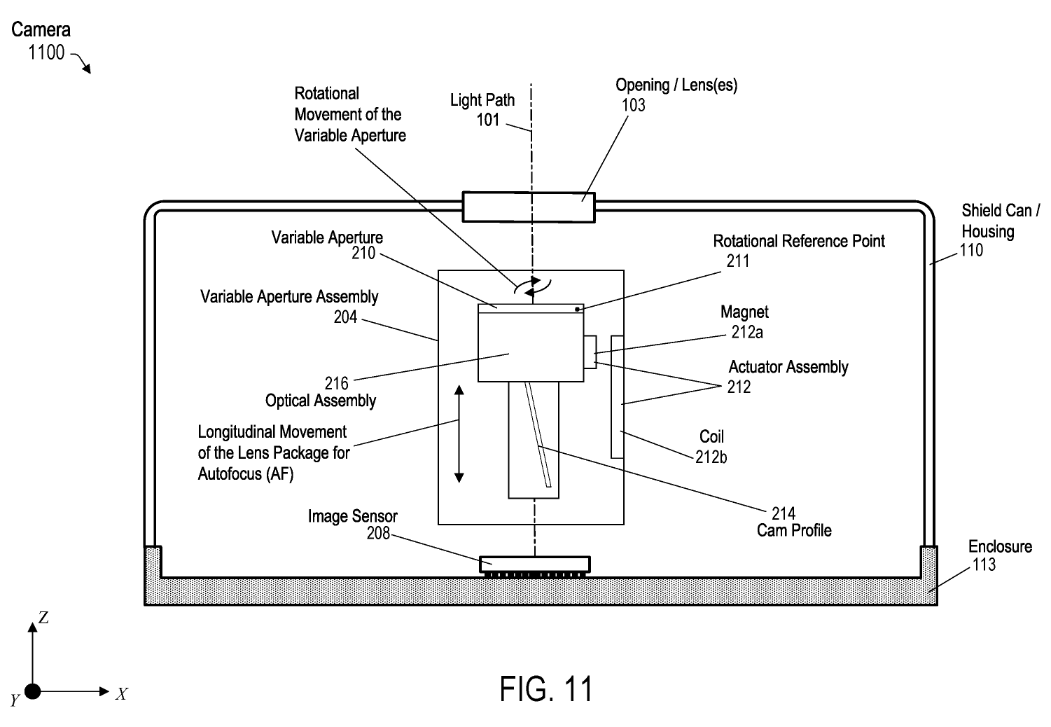

FIG. 11 illustrates components of an example camera 1100 having a variable aperture assembly 204 that may, for example, change the diameter of an aperture/opening to change an amount of light that reaches lenses of an optical assembly and/or an image sensor in small form factor cameras, according to at least some embodiments. FIG. 11 shows a cross-sectional view of the camera 1100 with the variable aperture assembly 204. The variable aperture assembly 204 of FIG. 11 may include one or more same or similar features as the features described with respect to or illustrated in FIGS. 1, 2, 3, 4, 5, 6, 7, 8A, 8B, 8C, 8D, 9A, 9B, 9C, 9D, 10, 12, and 13. The example X-Y-Z coordinate system shown in FIG. 11 may be used to discuss aspects of components and/or systems, and may apply to embodiments described throughout this disclosure.

As shown in FIG. 11, the camera 1100 may include the shield can / housing 110, the enclosure 113, the opening / lenses 103, a variable aperture assembly 204, and an image sensor 208. A light path 101 may extend from an environment exterior to the camera 1100, through the opening / lens(es) 103, extend through the variable aperture assembly 204 including the variable aperture 210 and the optical assembly 216, and reach the image sensor 208. It should be understood that the light path 101 extending through the variable aperture assembly 204 including the variable aperture 210 and the optical assembly 216 and between the environment external to the camera 1100 and the image sensor 208 may be considered an optical axis.

The variable aperture assembly 204 may be positioned along the light path 101 between the environment external to the camera 1100 and the image sensor 208. The variable aperture assembly 204 may include the optical assembly 216, an AF actuator assembly 212, a variable aperture 210, and a cam profile 214. As shown in FIG. 11, the AF actuator assembly 212 may include a magnet 212a attached to the moving optical assembly 216 a coil 212b attached to a stationary component of the variable aperture assembly 204 or a stationary component of the camera 100. A magnetic field from the magnets 212a may interact with current flowing through the coils 212b creating Lorentz forces to move the optical assembly 216 and the variable aperture 210 in one or more directions along the light path 101 (e.g., along the optical axis) for AF.

As described herein, the variable aperture 210 may include a cam pin (e.g., cam pin 306 illustrated in FIG. 4) and a cam profile 214. For example, the cam pin may be attached to a rotor of the variable aperture assembly 204 (e.g., the variable aperture 210) and extend into the cam profile 214. The cam profile 214 may extend both along the optical axis or light path 101 and at least partially around the optical axis or light path 101. When the AF actuators assembly 212 to move the optical assembly 216 along the optical axis or light path 101 for AF is activated, the optical assembly 216 moves along the optical axis or light path 101 for AF. As the optical assembly 216 moves along the optical axis or light path 101 for AF, the cam pin in the cam profile 214 moves within the cam profile 214 following the shape of the cam profile 214 and causes the rotor of the variable aperture 210 or of the variable aperture assembly 204 to move relative to the stator of the variable aperture 210 of the variable aperture assembly 204 creating a torsion load for driving the actuation of the overlapping mechanical blades between and including the fully open position and the fully actuated position. As the overlapping mechanical blades actuate, they extend into the opening of the rotor and stator reducing the diameter of the opening and the variable aperture 210 and thus reducing the amount of light that passes through the variable aperture 210 and to the lenses of the optical assembly 216 and/or the image sensor 208 of the camera 1000.

FIG. 12 illustrates a schematic representation of an example device 1200 that may include a camera (e.g., as described herein with respect to FIGS. 1, 2, 3, 4, 5, 6, 7, 8A, 8B, 8C, 8D, 9A, 9B, 9C, 9D, 10, 11, and 13), in accordance with some embodiments. In some embodiments, the device 1200 may be a mobile device and/or a multifunction device. In various embodiments, the device 1200 may be any of various types of devices, including, but not limited to, a personal computer system, desktop computer, laptop, notebook, tablet, slate, pad, or netbook computer, mainframe computer system, handheld computer, workstation, network computer, a camera, a set top box, a mobile device, an augmented reality (AR) and/or virtual reality (VR) headset, a consumer device, video game console, handheld video game device, application server, storage device, a television, a video recording device, a peripheral device such as a switch, modem, router, or in general any type of computing or electronic device.

In some embodiments, the device 1200 may include a display system 1202 (e.g., comprising a display and/or a touch-sensitive surface) and/or one or more cameras 1204. In some non-limiting embodiments, the display system 1202 and/or one or more front-facing cameras 1204a may be provided at a front side of the device 1200, e.g., as indicated in FIG. 12. Additionally, or alternatively, one or more rear-facing cameras 1204b may be provided at a rear side of the device 1200. In some embodiments comprising multiple cameras 1204, some or all of the cameras may be the same as, or similar to, each other. Additionally, or alternatively, some or all of the cameras may be different from each other. In various embodiments, the location(s) and/or arrangement(s) of the camera(s) 1204 may be different than those indicated in FIG. 12.

Among other things, the device 1200 may include memory 1206 (e.g., comprising an operating system 1208 and/or application(s)/program instructions 1210), one or more processors and/or controllers 1212 (e.g., comprising CPU(s), memory controller(s), display controller(s), and/or camera controller(s), etc.), and/or one or more sensors 1216 (e.g., orientation sensor(s), proximity sensor(s), and/or position sensor(s), etc.). In some embodiments, the device 1200 may communicate with one or more other devices and/or services, such as computing device(s) 1218, cloud service(s) 1220, etc., via one or more networks 1222. For example, the device 1200 may include a network interface (e.g., network interface 1210) that enables the device 1200 to transmit data to, and receive data from, the network(s) 1222. Additionally, or alternatively, the device 1200 may be capable of communicating with other devices via wireless communication using any of a variety of communications standards, protocols, and/or technologies.

FIG. 13 illustrates a schematic block diagram of an example computing device, referred to as computer system 1300, that may include or host embodiments of a camera (e.g., as described herein with respect to FIGS. 1, 2, 3, 4, 5, 6, 7, 8A, 8B, 8C, 8D, 9A, 9B, 9C, 9D, 10, 11, and 12). In addition, computer system 1300 may implement methods for controlling operations of the camera and/or for performing image processing images captured with the camera. In some embodiments, the device 1200 (described herein with reference to FIG. 12) may additionally, or alternatively, include some or all of the functional components of the computer system 1300 described herein.

The computer system 1300 may be configured to execute any or all of the embodiments described above. In different embodiments, computer system 1300 may be any of various types of devices, including, but not limited to, a personal computer system, desktop computer, laptop, notebook, tablet, slate, pad, or netbook computer, mainframe computer system, handheld computer, workstation, network computer, a camera, a set top box, a mobile device, an augmented reality (AR) and/or virtual reality (VR) headset, a consumer device, video game console, handheld video game device, application server, storage device, a television, a video recording device, a peripheral device such as a switch, modem, router, or in general any type of computing or electronic device.

In the illustrated embodiment, computer system 1300 includes one or more processors 1302 coupled to a system memory 1304 via an input/output (I/O) interface 1306. Computer system 1300 further includes one or more cameras 1308 coupled to the I/O interface 1306. Computer system 1300 further includes a network interface 1310 coupled to I/O interface 1306, and one or more input/output devices 1312, such as cursor control device 1314, keyboard 1316, and display(s) 1318. In some cases, it is contemplated that embodiments may be implemented using a single instance of computer system 1300, while in other embodiments multiple such systems, or multiple nodes making up computer system 1300, may be configured to host different portions or instances of embodiments. For example, in one embodiment some elements may be implemented via one or more nodes of computer system 1300 that are distinct from those nodes implementing other elements.

In various embodiments, computer system 1300 may be a uniprocessor system including one processor 1302, or a multiprocessor system including several processors 1302 (e.g., two, four, eight, or another suitable number). Processors 1302 may be any suitable processor capable of executing instructions. For example, in various embodiments processors 1302 may be general-purpose or embedded processors implementing any of a variety of instruction set architectures (ISAs), such as the x86, PowerPC, SPARC, or MIPS ISAs, or any other suitable ISA. In multiprocessor systems, each of processors 1302 may commonly, but not necessarily, implement the same ISA.

System memory 1304 may be configured to store program instructions 1320 accessible by processor 1302. In various embodiments, system memory 1304 may be implemented using any suitable memory technology, such as static random access memory (SRAM), synchronous dynamic RAM (SDRAM), nonvolatile/Flash-type memory, or any other type of memory. Additionally, existing camera control data 1322 of memory 1304 may include any of the information or data structures described above. In some embodiments, program instructions 1320 and/or data 1322 may be received, sent or stored upon different types of computer-accessible media or on similar media separate from system memory 1304 or computer system 1300. In various embodiments, some or all of the functionality described herein may be implemented via such a computer system 1300.

In one embodiment, I/O interface 1306 may be configured to coordinate I/O traffic between processor 1302, system memory 1304, and any peripheral devices in the device, including network interface 1310 or other peripheral interfaces, such as input/output devices 1312. In some embodiments, I/O interface 1306 may perform any necessary protocol, timing or other data transformations to convert data signals from one component (e.g., system memory 1304) into a format suitable for use by another component (e.g., processor 1302). In some embodiments, I/O interface 1306 may include support for devices attached through various types of peripheral buses, such as a variant of the Peripheral Component Interconnect (PCI) bus standard or the Universal Serial Bus (USB) standard, for example. In some embodiments, the function of I/O interface 1306 may be split into two or more separate components, such as a north bridge and a south bridge, for example. Also, in some embodiments some or all of the functionality of I/O interface 1306, such as an interface to system memory 1304, may be incorporated directly into processor 1302.

Network interface 1310 may be configured to allow data to be exchanged between computer system 1300 and other devices attached to a network 1324 (e.g., carrier or agent devices) or between nodes of computer system 1300. Network 1324 may in various embodiments include one or more networks including but not limited to Local Area Networks (LANs) (e.g., an Ethernet or corporate network), Wide Area Networks (WANs) (e.g., the Internet), wireless data networks, some other electronic data network, or some combination thereof. In various embodiments, network interface 1310 may support communication via wired or wireless general data networks, such as any suitable type of Ethernet network, for example; via telecommunications/telephony networks such as analog voice networks or digital fiber communications networks; via storage area networks such as Fibre Channel SANs, or via any other suitable type of network and/or protocol.

Input/output devices 1312 may, in some embodiments, include one or more display terminals, keyboards, keypads, touchpads, scanning devices, voice or optical recognition devices, or any other devices suitable for entering or accessing data by one or more computer systems 1300. Multiple input/output devices 1312 may be present in computer system 1300 or may be distributed on various nodes of computer system 1300. In some embodiments, similar input/output devices may be separate from computer system 1300 and may interact with one or more nodes of computer system 1300 through a wired or wireless connection, such as over network interface 1310.

Those skilled in the art will appreciate that computer system 800 is merely illustrative and is not intended to limit the scope of embodiments. In particular, the computer system and devices may include any combination of hardware or software that can perform the indicated functions, including computers, network devices, Internet appliances, PDAs, wireless phones, pagers, etc. Computer system 800 may also be connected to other devices that are not illustrated, or instead may operate as a stand-alone system. In addition, the functionality provided by the illustrated components may in some embodiments be combined in fewer components or distributed in additional components. Similarly, in some embodiments, the functionality of some of the illustrated components may not be provided and/or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 800 may be transmitted to computer system 800 via transmission media or signals such as electrical, electromagnetic, or digital signals, conveyed via a communication medium such as a network and/or a wireless link. Various embodiments may further include receiving, sending or storing instructions and/or data implemented in accordance with the foregoing description upon a computer-accessible medium. Generally speaking, a computer-accessible medium may include a non-transitory, computer-readable storage medium or memory medium such as magnetic or optical media, e.g., disk or DVD/CD-ROM, volatile or non-volatile media such as RAM (e.g. SDRAM, DDR, RDRAM, SRAM, etc.), ROM, etc. In some embodiments, a computer-accessible medium may include transmission media or signals such as electrical, electromagnetic, or digital signals, conveyed via a communication medium such as network and/or a wireless link.

The methods described herein may be implemented in software, hardware, or a combination thereof, in different embodiments. In addition, the order of the blocks of the methods may be changed, and various elements may be added, reordered, combined, omitted, modified, etc. Various modifications and changes may be made as would be obvious to a person skilled in the art having the benefit of this disclosure. The various embodiments described herein are meant to be illustrative and not limiting. Many variations, modifications, additions, and improvements are possible. Accordingly, plural instances may be provided for components described herein as a single instance. Boundaries between various components, operations and data stores are somewhat arbitrary, and particular operations are illustrated in the context of specific illustrative configurations. Other allocations of functionality are envisioned and may fall within the scope of claims that follow. Finally, structures and functionality presented as discrete components in the example configurations may be implemented as a combined structure or component. These and other variations, modifications, additions, and improvements may fall within the scope of embodiments as defined in the claims that follow.

What is claimed is:

1. A camera, comprising:
an image sensor; and
a variable aperture assembly comprising:
an optical assembly having one or more lenses, wherein the optical assembly is positioned along a light path that extends through the one or more lenses to the image sensor,
an actuator configured to move the optical assembly along the light path,
a variable aperture mechanism configured to modulate a diameter of an aperture that is positioned along the light path and that is adjacent the optical assembly, and
a mechanical coupling configured activate the variable aperture mechanism to modulate the diameter of the aperture during movement of the optical assembly along the light path.

2. The camera of claim 1, wherein the mechanical coupling comprises:
a pin protruding from a rotor of the variable aperture mechanism; and
a cam that receives the pin and extends in a direction along the light path.

3. The camera of claim 1, wherein the actuator comprises a voice coil motor (VCM) actuator having at least one coil and at least one magnet.

4. The camera of claim 3, wherein the at least one coil is attached to a stationary component of the camera, and wherein the at least one magnet is attached to the optical assembly.

5. The camera of claim 1, wherein the variable aperture mechanism is positioned adjacent the optical assembly and on an object side of the optical assembly.

6. The camera of claim 1, wherein the variable aperture mechanism is positioned adjacent the optical assembly and on an image side of the optical assembly.

7. The camera of claim 1, wherein the mechanical coupling is configured to actuate the variable aperture mechanism to reduce the diameter of the aperture as the optical assembly moves in a direction along the light path away from the image sensor.

8. A variable aperture assembly, comprising:
an optical assembly having one or more lenses, wherein the optical assembly is configured to be positioned along a light path that extends through the one or more lenses and to an image sensor of a camera;
an actuator configured to move the optical assembly along the light path;
a variable aperture mechanism configured to modulate a diameter of an aperture that is positioned along the light path and that is adjacent the optical assembly; and
a mechanical coupling configured activate the variable aperture mechanism to modulate the diameter of the aperture during movement of the optical assembly along the light path.

9. The variable aperture assembly of claim 8, wherein the mechanical coupling comprises:
a pin protruding from a rotor of the variable aperture; and
a cam that receives the pin and extends in a direction along the light path.

10. The variable aperture assembly of claim 8, wherein the actuator comprises a voice coil motor (VCM) actuator having at least one coil and at least one magnet.

11. The variable aperture assembly of claim 10, wherein the at least one coil is attached to a stationary component of the camera, and wherein the at least one magnet is attached to the optical assembly.

12. The variable aperture assembly of claim 8, wherein the variable aperture mechanism is positioned adjacent the optical assembly and on an object side of the optical assembly.

13. The variable aperture assembly of claim 8, wherein the variable aperture mechanism is positioned adjacent the optical assembly and on an image side of the optical assembly.

14. The variable aperture assembly of claim 8, wherein the mechanical coupling is configured to actuate the variable aperture mechanism to reduce the diameter of the aperture as the optical assembly moves in a direction along the light path away from the image sensor.

15. A device, comprising:
a display;
a camera;
one or more processors; and
memory storing program instructions executable by the one or more processors to cause images captured by the camera to be displayed on the display;
the camera comprising:
an image sensor; and
a variable aperture assembly comprising:
an optical assembly having one or more lenses, wherein the optical assembly is positioned along a light path that extends through the one or more lenses to the image sensor,
an actuator configured to move the optical assembly along the light path,
a variable aperture mechanism configured to modulate a diameter of an aperture that is positioned along the light path and that is adjacent the optical assembly, and
a mechanical coupling configured activate the variable aperture mechanism to modulate the diameter of the aperture during movement of the optical assembly along the light path.

16. The device of claim 15, wherein the mechanical coupling comprises:
a pin protruding from a rotor of the variable aperture; and
a cam that receives the pin and extends in a direction along the light path.

17. The device of claim 15, wherein the actuator comprises a voice coil motor (VCM) actuator having at least one coil and at least one magnet.

18. The device of claim 17, wherein the at least one coil is attached to a stationary component of the camera, and wherein the at least one magnet is attached to the optical assembly.

19. The device of claim 15, wherein the variable aperture mechanism is positioned adjacent the optical assembly and on an object side of the optical assembly.

20. The device of claim 15, wherein the mechanical coupling is configured to actuate the variable aperture mechanism to reduce the diameter of the aperture as the optical assembly moves in a direction along the light path away from the image sensor.
